(19) United States
(12) Patent Application Publication
(10) Pub. No.: US 2017/0278076 A1
(43) Pub. Date: Sep. 28, 2017

(54) INPUT ASSISTANCE METHOD, COMPUTER-READABLE RECORDING MEDIUM, AND INPUT ASSISTANCE DEVICE

(71) Applicants: FUJITSU LIMITED, Kawasaki-shi (JP); FUJITSU FSAS INC., Kawasaki-shi (JP)

(72) Inventors: Kenzo Watanabe, Yokohama (JP); Taiji Uchida, Kawasaki (JP); Yoshihito Nakamae, Kawasaki (JP); Takayoshi Watanabe, Yokohama (JP); Taihei Ishikuro, Yokohama (JP)

(73) Assignees: FUJITSU LIMITED, Kawasaki-shi (JP); FUJITSU FSAS INC., Kawasaki-shi (JP)

(21) Appl. No.: 15/457,041

(22) Filed: Mar. 13, 2017

(30) Foreign Application Priority Data
Mar. 23, 2016 (JP) 2016-059084

(51) Int. Cl. G06Q 10/00; G06F 3/0482

(52) U.S. Cl. CPC G06Q 10/20; G06F 3/0482

(57) ABSTRACT

An input assistance device executes, regarding an incident case including a plurality of times, retrieval of the incident case in operation management. The input assistance device detects a first click operation to a specific item of the incident case retrieved in response to an input of at least any of the plurality of items included in the incident case. The input assistance device duplicates a content of the specific item of the incident case to an inputting item corresponding to the specific item in response to the detected first click operation.

### CROSS-REFERENCE TO RELATED APPLICATION

This application is based upon and claims the benefit of priority of the prior Japanese Patent Application No. 2016-059084, filed on Mar. 23, 2016, the entire contents of which are incorporated herein by reference.

### FIELD

The embodiments discussed herein are related to an input assistance method, a computer-readable recording medium, and an input assistance device.

### BACKGROUND

In operation management of an information system, an inquiry from a user regarding a provided service is treated in management units called incidents, and a provisional response to the inquiry is performed. To be specific, a person in charge at the service desk registers the incident to the management system, upon receiving the inquiry from the user, and performs management and response in units of registered incident. When the person in charge at the service desk registers the incident, the response to the inquiry of the user is started. Further, with the incident registration, a notification of start of response (first call back) is provided to the user who had made the inquiry.

The registration of the incident is a starting-point process of incident management, and therefore the person in charge at the service desk is needed to perform input processing for the registration of the incident promptly with appropriate content. In addition, information to be registered as the incident may include detailed description of inquiry content and response content, and some information takes time to create from scratch. Recently, a technology to display information of an incident input in the past item by item, and reflect input content of a newly input incident on the display is known.
Patent Literature 1: International Publication Pamphlet No. WO 2009/054215

In recent years, retrieval of incidents including most recently accumulated incidents and having items similar to an item to be retrieved are possible by use of a retrieval server such as Elasticsearch (registered trademark) based on Apache Lucene (registered trademark).

In a case where a most recently registered case is included in an object to be retrieved, and the incident registration is speeded up using a retrieval server capable of similarity retrieval, an input of a specific item of a past incident may be desired to be used for a corresponding item as it is, and the input of a specific item may be desired to be used for the corresponding item and for other items. In addition, in a case of duplication, a plurality of items may be successively duplicated. The above-described technology does not improve efficiency of successive transcription of a plurality of items, and registration differently using duplication and utilization, only by conducting bulk paste on the paste side, which corresponds to the copy side.

### SUMMARY

According to an aspect of an embodiment, an input assistance method includes accepting, in an incident case including a plurality of items in operation management, a first click operation to a specific item of the incident case retrieved in response to an input of at least any of the plurality of items, using a processor; and duplicating a content of the specific item of the incident case to an inputting item corresponding to the specific item in response to the first click operation, using the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an example of an overall configuration of a system according to a first embodiment;

FIG. 2 is a diagram for describing registration and retrieval of an incident;

FIG. 3 is a functional block diagram illustrating a functional configuration of the system according to the first embodiment;

FIG. 4 is a diagram illustrating an example of an incident registration screen;

FIG. 5 is a diagram illustrating an example of a screen of incident retrieval results;

FIG. 6 is a diagram illustrating an example of a screen of modal display;

FIG. 7 is a diagram illustrating an example of an operation at the time of a left click;

FIG. 8 is a diagram illustrating an example of an operation at the time of a right click;

FIG. 9 is a diagram illustrating an example of information stored in an incident DB;

FIG. 10 is a diagram for describing a click operation;

FIG. 11 is a diagram for describing successive processing by click operations;

FIG. 12 is a diagram for describing the successive processing by click operations;

FIG. 13 is a diagram for describing overwrite by a right click operation;

FIG. 14 is a diagram for describing execution trigger of retrieval processing;

FIG. 15 is a flowchart illustrating a flow of the retrieval processing;

FIG. 16 is a flowchart illustrating a flow of duplication processing;

FIG. 17 is a flowchart illustrating a flow of transcription processing; and

FIG. 18 is a diagram for describing an example of a hardware configuration.

### DESCRIPTION OF EMBODIMENTS

Preferred embodiments of the present invention will be explained with reference to accompanying drawings. Note that the present invention is not limited by the embodiments.

### [a] First Embodiment

Overall Configuration

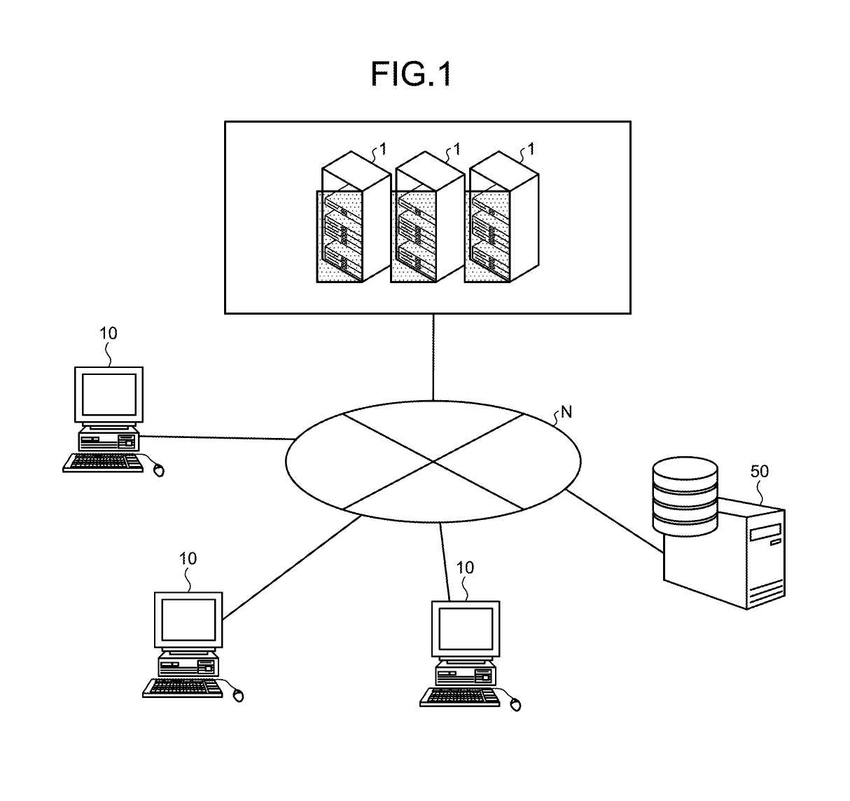

FIG. 1 is a diagram for describing an example of an overall configuration of a system according to a first embodiment. As illustrated in FIG. 1, this system is an incident management system including at least one service providing server 1 that provides customers with various services, a terminal device 10 used by a manager who manages the various services, and an incident DB server 50 that stores an incident case (which may be simply described as “incident” in the present embodiment).

The incident management system illustrated in FIG. 1 provides an incident retrieval function and a registration function for the terminal device 10 by mounting a retrieval engine having a similarity retrieval function such as Elasticsearch (registered trademark) based on Apache Lucene (registered trademark). Note that the devices illustrated in FIG. 1 are connected with one another in a communicative manner by a network N such as the Internet.

The service providing server 1 is an example of a server device that provides the customers with various services, and failure management software is resident therein. The failure management software monitors a failure on a regular basis, and displays the failure on a predetermined display device or displays the failure on the terminal device 10 that manages the service in which the failure has occurred, when detecting the failure.

The terminal device 10 is an example of a computer that monitors the failure of the service providing server 1. When there is an inquiry from the customer or the failure is detected in the system, the terminal device 10 registers an incident regarding a response to the inquiry or the failure to the incident DB server 50. Further, the terminal device 10 retrieves an appropriate incident from the incident DB server 50 in order to retrieve a similar failure, or a response to the similar failure, when a failure has occurred.

The incident DB server 50 is a server device that manages the incident occurring in the service providing server 1, and provides the retrieval engine having the similarity retrieval function. The incident DB server 50 registers an input incident to the DB upon receiving a registration request of the incident from the terminal device 10, and retrieves the appropriate incident from the DB and replies to the terminal device 10 upon receiving a retrieval request of the incident from the terminal device 10. Further, basically, the incident registered to the incident DB server 50 is not able to be deleted once registered unless otherwise deleted by a manager of the incident DB server 50. Therefore, the incident is registered at all times.

Description of Registration and Retrieval

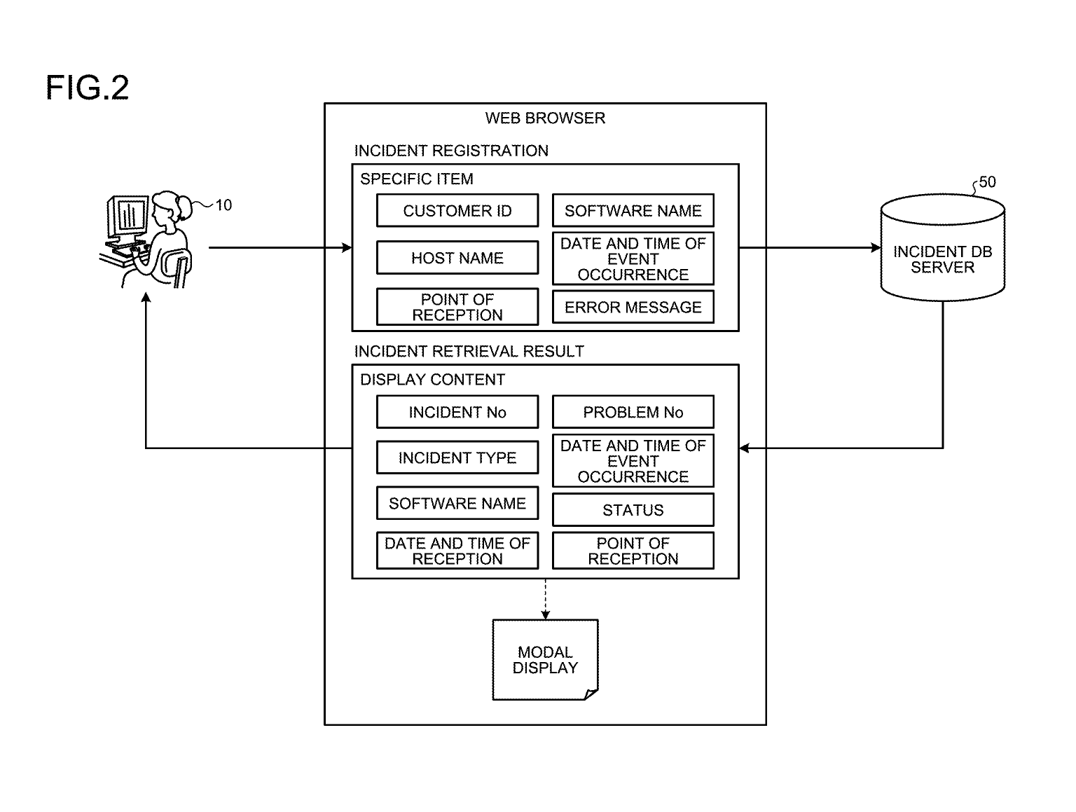

Next, processing of retrieving or registering the incident, using the terminal device 10, will be described. FIG. 2 is a diagram for describing registration and retrieval of the incident. As illustrated in FIG. 2, the terminal device 10 access the DB of the incident DB server 50, and executes retrieval and registration of the incident, using a web browser on which an execution environment of JavaScript (registered trademark) (which may be simply described as “script” in the present embodiment) is mounted.

For example, when registering the incident, the terminal device 10 access the incident DB server 50, using the Web browser, and displays an incident registration screen as a top screen. Then, the terminal device 10 receives inputs of specific items including “a customer ID, a software name, a host name, date and time of occurrence of event, a point of reception, and an error message” that identify the incident on the incident registration screen from the manager. Then, a registration query is issued from the terminal device 10 to the incident DB server 50, and the incident DB server 50 executes the registration query, thereby to register the input incident to the DB.

Further, when retrieving the incident, the terminal device 10 access the incident DB server 50, using the Web browser, and displays the incident registration screen, similarly to the registration. Then, the terminal device 10 receives an input of a keyword on the incident registration screen from the manager. Then, the terminal device 10 issues a retrieval query to the incident DB server 50, and the incident DB server 50 executes the retrieval query to retrieve the appropriate incident from the DB. After that, when the incident DB server 50 replies with retrieval results, the terminal device 10 displays the retrieval results on the Web browser.

Further, the terminal device 10 displays, on a modal window (which may be simply described as “modal” in the present embodiment), a retrieval result selected by mouse-over from the plurality of retrieval results displayed on the Web browser. Then, the terminal device 10 left-clicks or right-clicks the retrieval result displayed on the modal, thereby to execute duplication and paste of the retrieval result of the incident to the items on the incident registration screen.

In such a system, the terminal device 10 duplicates, in inputting an incident case having a plurality of items in operation management, content of a specific item of an incident case to an inputting item corresponding to the specific item, in response to a first click operation to the specific item of the incident case retrieved in response to an input of at least any of the plurality of items.

For example, the terminal device 10 duplicates input content registered in the right-clicked item, of the retrieval results displayed on the modal, to the appropriate item on the incident registration screen without storing the input content to a temporary area such as a clipboard managed by an operating system. Note that such duplication may be described as “transcription” in the present embodiment.

Meanwhile, the terminal device 10 stores the input content registered to the left-clicked item, of the retrieval results displayed on the modal, to the temporary area such as the clipboard managed by the operation system without duplicating the input content to the appropriate item on the incident registration screen. Such duplication may be simply described as “copy” in the present embodiment.

In doing so, the terminal device 10 can improve efficiency of information registration, differently using duplication and utilization.

Functional Configuration

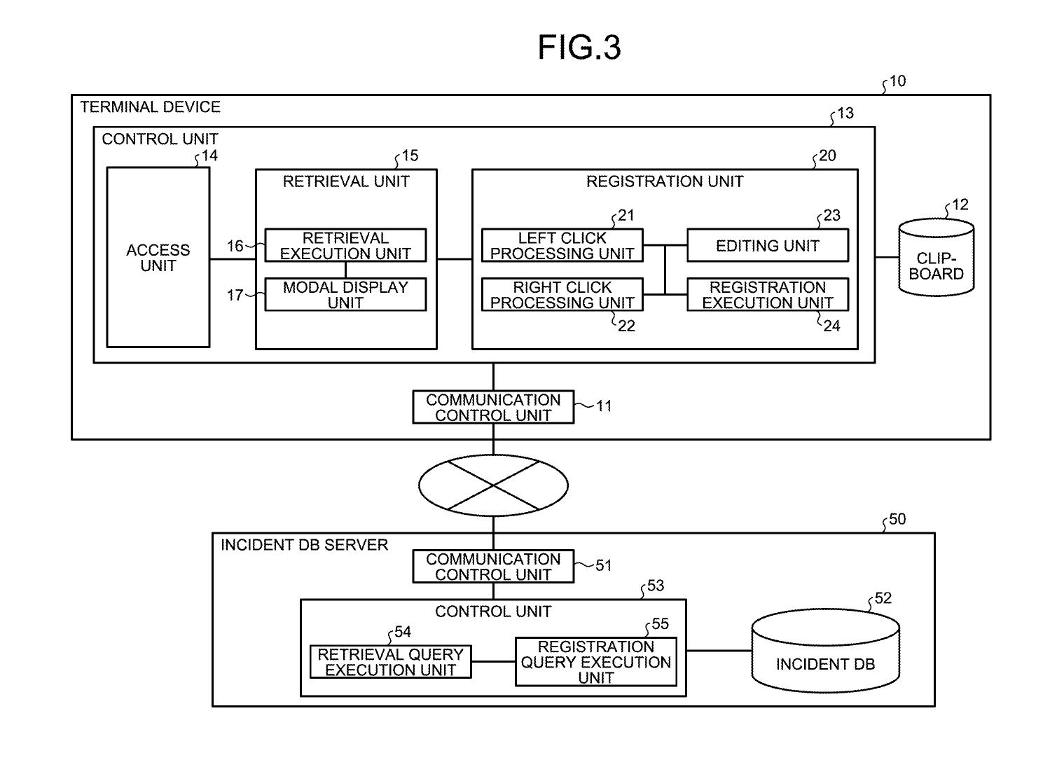

FIG. 3 is a functional block diagram illustrating a functional configuration of the system according to the first embodiment. Here, the terminal device 10 and the incident DB server 50 will be described.

Functional Configuration of Terminal Device 10

As illustrated in FIG. 3, the terminal device 10 includes a communication control unit 11, a clipboard 12, and a control unit 13.

The communication control unit 11 is a processing unit that controls communication between the own device and other devices including the incident DB server 50 and the like, and is, for example, a network interface card. For example, the communication control unit 11 executes control regarding the Web server between the own device and the incident DB server 50, and receives a failure notification and the like from the service providing server 1. Further, the communication control unit 11 transmits the retrieval query, the registration query, and the like to the incident DB server 50.

The clipboard 12 is a temporary area provided by the operating system of the terminal device 10. The clipboard 12 is overwritten with a character string processed by a left click processing unit 21 described below.

The control unit 13 is a processing unit that controls processing of the entire terminal device 10, and is, for example, a processor. The control unit 13 includes an access unit 14, a retrieval unit 15, and a registration unit 20. Note that the access unit 14, the retrieval unit 15, and the registration unit 20 are examples of electronic circuits included in the processor, or examples of processes executed by the processor.

The access unit 14 is a processing unit that executes a Web access, using the Web browser on which the execution environment of the script is mounted. For example, when the Web browser is started by the manager, the access unit 14 accesses the incident DB server 50, and displays the incident registration screen as a top page. After that, the access unit 14 establishes communication, using the Web browser, and executes display of information, and the like.

The retrieval unit 15 is a processing unit that displays the incident registration screen, using the Web browser, and retrieves the incident to be registered to the incident DB server 50. The retrieval unit 15 includes a retrieval execution unit 16 and a modal display unit 17.

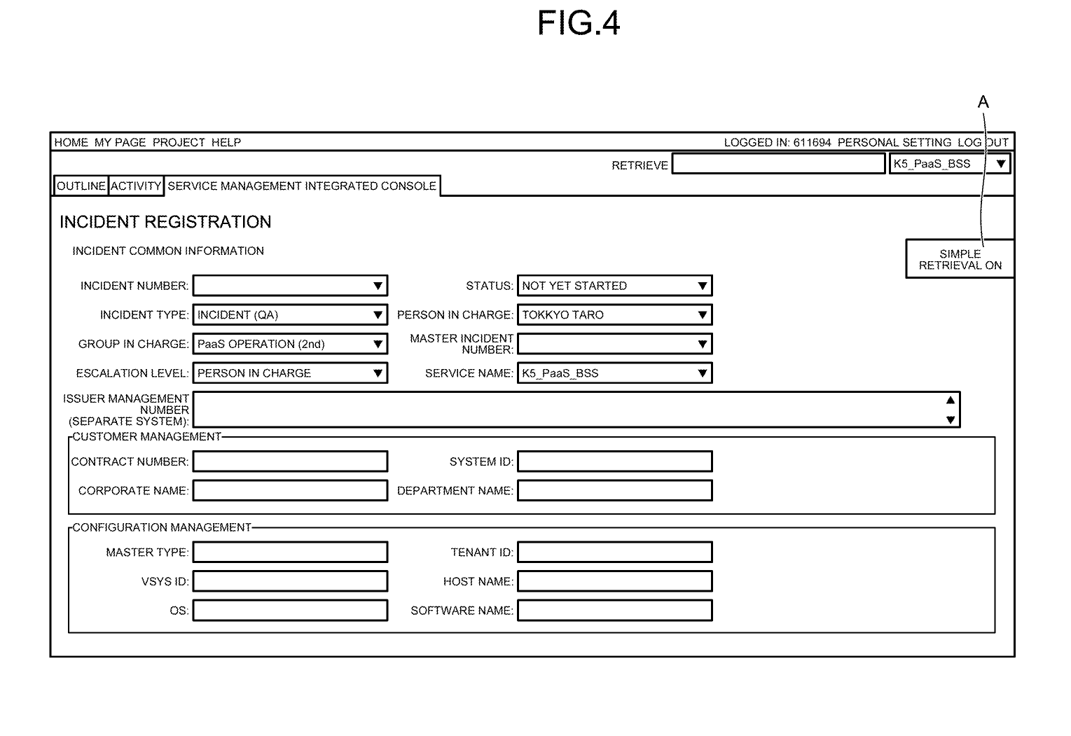

The retrieval execution unit 16 is a processing unit that detects the character string input on the incident registration screen. FIG. 4 is a diagram illustrating an example of the incident registration screen. As illustrated in FIG. 4, the incident registration screen includes an icon A of simple retrieval and incident common information. The icon A of simple retrieval allows switching of ON/OFF of the simple retrieval by being clicked. The incident retrieval function is effective in ON display, and the incident retrieval function is ineffective in OFF display.

The incident common information includes an incident number, a status, an incident type, a name of a person in charge, a group in charge, a master incident number, an escalation level, a service name, an issuer control number, customer management, configuration management, and the like. Further, the customer management includes a contract number, a system ID, a corporate name, a department name, and the like. The configuration management includes a master type, a tenant ID, VSYS ID, a host name, an OS, a software name, and the like. The information described here is an example of registration information as an incident, and the setting can be arbitrarily changed.

Then, when the retrieval execution unit 16 detects a character input to any item, using the script, in an ON state of the simple retrieval, in which the icon A of the simple retrieval is in ON display, the retrieval execution unit 16 issues the retrieval query with the input character string as a keyword to the incident DB server 50. For example, in a case where an “error” is input to the point of reception, the retrieval execution unit 16 issues “point of reception: error” as the retrieval query.

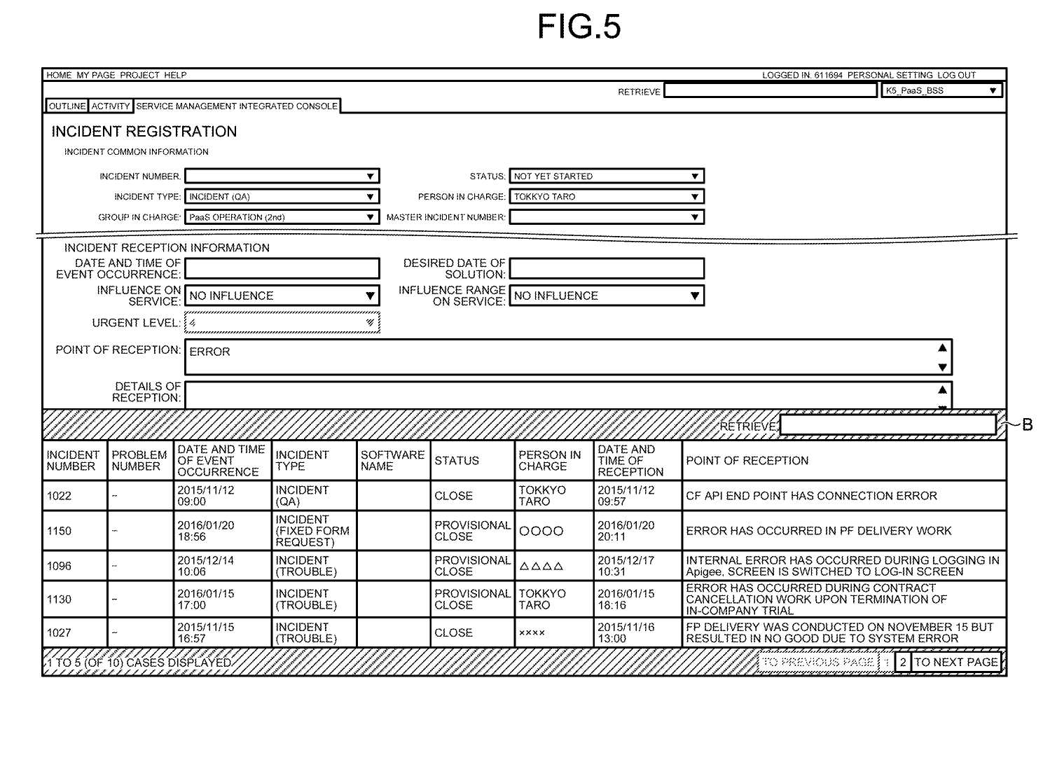

FIG. 5 is a diagram illustrating an example of a screen of incident retrieval results. As illustrated in FIG. 5, a retrieval result screen B of the incident retrieval results is superimposed and displayed on the incident registration screen. Information displayed as the retrieval results may be the incidents registered to the incident DB server 50 as it is, or may be a screen obtained by editing the retrieval results for the screen. Further, FIG. 5 illustrates an example of displaying the retrieval result screen B right under the “point of reception” in which the “error” has been input on the incident registration screen. However, the place to display the information is not limited to the example, and the setting can be arbitrarily changed.

As described above, when the character string is input to the inputting item on the incident registration screen in the ON state of the simple retrieval, in which the icon A of the simple retrieval is in ON display, the retrieval execution unit 16 automatically executes the retrieval, and automatically displays the retrieval results. Here, the retrieval execution unit 16 has some conditions in performing the automatic retrieval.

For example, in a case where no operation continues for a predetermined time (for example, 1.5 seconds) from when the character string is input to the inputting item, the retrieval execution unit 16 executes the automatic retrieval. In doing so, a user (manager) can execute the incident retrieval without feeling stress.

Further, when the retrieval execution unit 16 detects inputs to a plurality of the inputting items, the retrieval execution unit 16 gives a higher priority to a last input character string. For example, assume that the retrieval execution unit 16 detects the input of the “error” to the point of reception within 1.5 seconds after detecting an input of “Tokkyo Taro” to the name of a person in charge. In this case, the retrieval execution unit 16 issues “name of a person in charge: Tokkyo Taro” and “point of reception: error” as the retrieval queries. At this time, the retrieval execution unit 16 sends information indicating which item is input later together with the retrieval queries, or sends the lase-input item first or last. After that, the retrieval execution unit 16 displays the retrieval results such that the incidents including the last-input “error” come to upper rows in the retrieval results.

Further, in a case where the character string is input to the inputting item by transcription by a right click described below, the retrieval execution unit 16 restrains the automatic retrieval. That is, when the retrieval execution unit 16 detects the character input by a right click processing unit 22, the retrieval execution unit 16 does not issue the retrieval query, and does not execute update of the retrieval screen. However, in a case where an increase/decrease in the characters occurs in the character string input by the right click processing unit 22, the retrieval execution unit 16 executes the automatic retrieval.

Note that the input of the character string and the increase/decrease in the character string are executed using the script, the execution environment of which is mounted on the Web browser. Further, as described above, there are the conditions of the automatic retrieval for the input characters. However, when the increase/decrease in the characters is detected, the automatic retrieval is executed.

Referring back to FIG. 3, the modal display unit 17 is a processing unit that displays the modal on the incident registration screen. To be specific, the modal display unit 17 displays, on the modal, the mouse-over incident on the retrieval result screen B of the incident retrieval results.

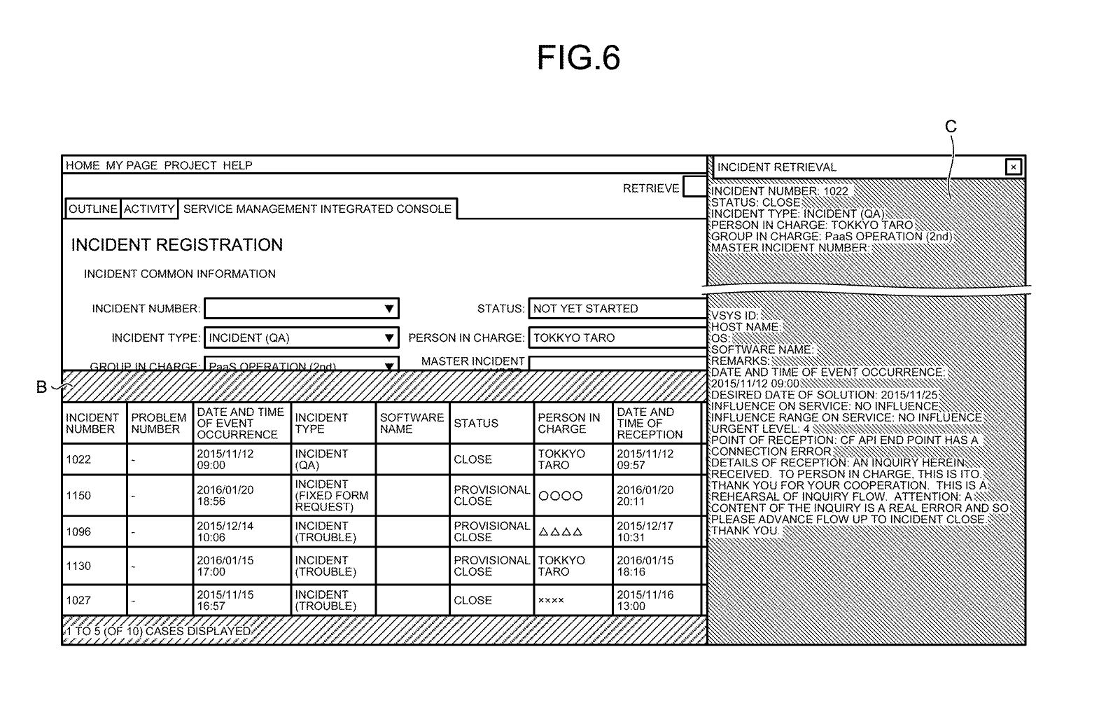

FIG. 6 is a diagram illustrating an example of a screen of modal display. As illustrated in FIG. 6, the modal display unit 17 displays, when an incident number “1022” on the retrieval result screen B is mouse-over, information of the incident registered as the incident number “1022” on a modal C. The information displayed on the modal C is information obtained by editing the information registered as the incident in a hypertext markup language (HTML) format. Further, items on the modal C are exactly matched with the items on the incident registration screen.

That is, the items including “an incident number, a status, an incident type, a name of a person in charge, . . . ” displayed on the modal C are the items existing on the incident registration screen. Note that the display area of the modal C illustrated in FIG. 6 is an example, and the setting can be arbitrarily changed.

The registration unit 20 is a processing unit that includes the left click processing unit 21, the right click processing unit 22, an editing unit 23, and a registration execution unit 24, and registers the incident to the incident DB server 50.

The left click processing unit 21 is a processing unit that executes copy to the clipboard 12 when detecting a left click, using the script. To be specific, when the left click processing unit 21 detects the left click on the modal C, the left click processing unit 21 copies the character string written in a place where the left click has been detected, to the clipboard 12.

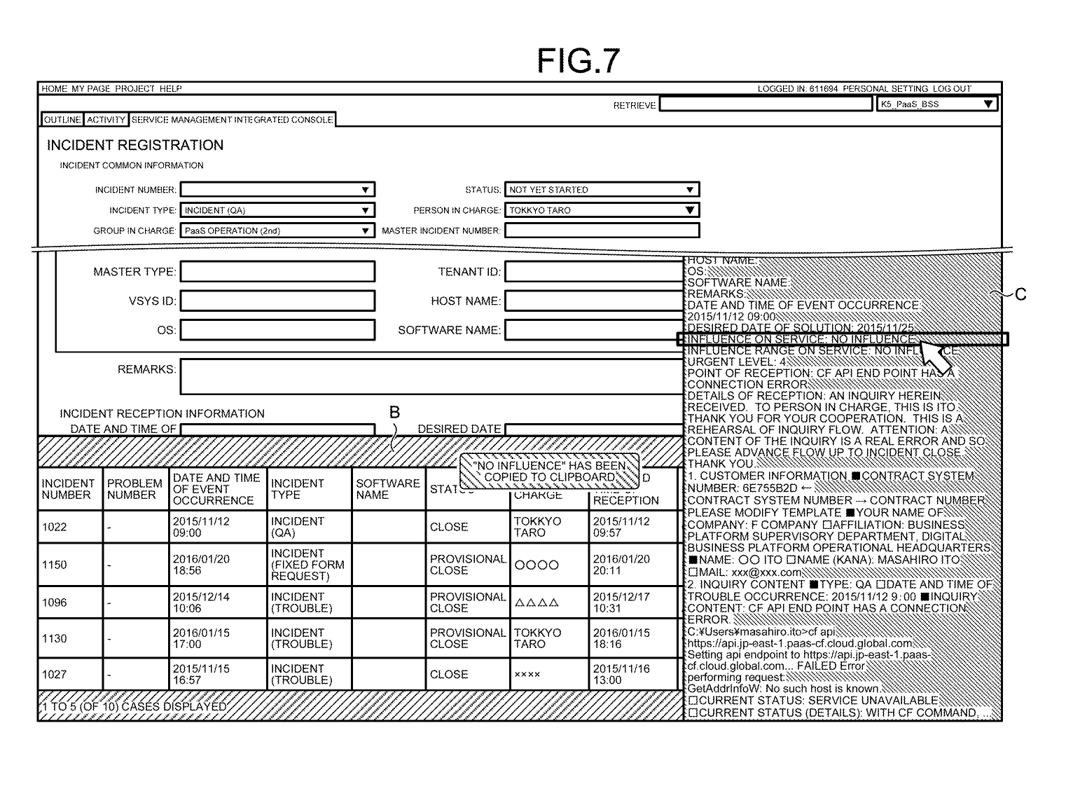

FIG. 7 is a diagram illustrating an example of an operation at the time of the left click. The screen illustrated in FIG. 7 indicates a state in which the retrieval result screen B and the modal C are displayed on the incident registration screen. In this state, when the left click processing unit 21 detects the left click on the modal C, the left click processing unit 21 identifies a tag of HTML in the position where the left click has been detected, and extracts an item name “influence on service” and a character string “no influence” specified by the tag. Then, the left click processing unit 21 copies the character string “no influence” and stores the character string to the clipboard 12. At this time, the left click processing unit 21 displays a message indicating that the copy has been made on the incident registration screen.

Note that the detection of the left click, and detection of the left-clicked position and the tag can be performed using functions of the script. However, an embodiment is not limited thereto, and various known technique can be employed.

The right click processing unit 22 is a processing unit that performs transcription to an appropriate item on the incident registration screen without performing copy to the clipboard 12 when detecting the right click, using the script. To be specific, when the right click processing unit 22 detects the right click on the modal C, the right click processing unit 22 holds the character string written in the place where the right click has been detected as a variable of the script. Then, the right click processing unit 22 transcribes the character string held as the variable of the script to the same item as the item right-clicked on the modal C, of the items on the incident registration screen.

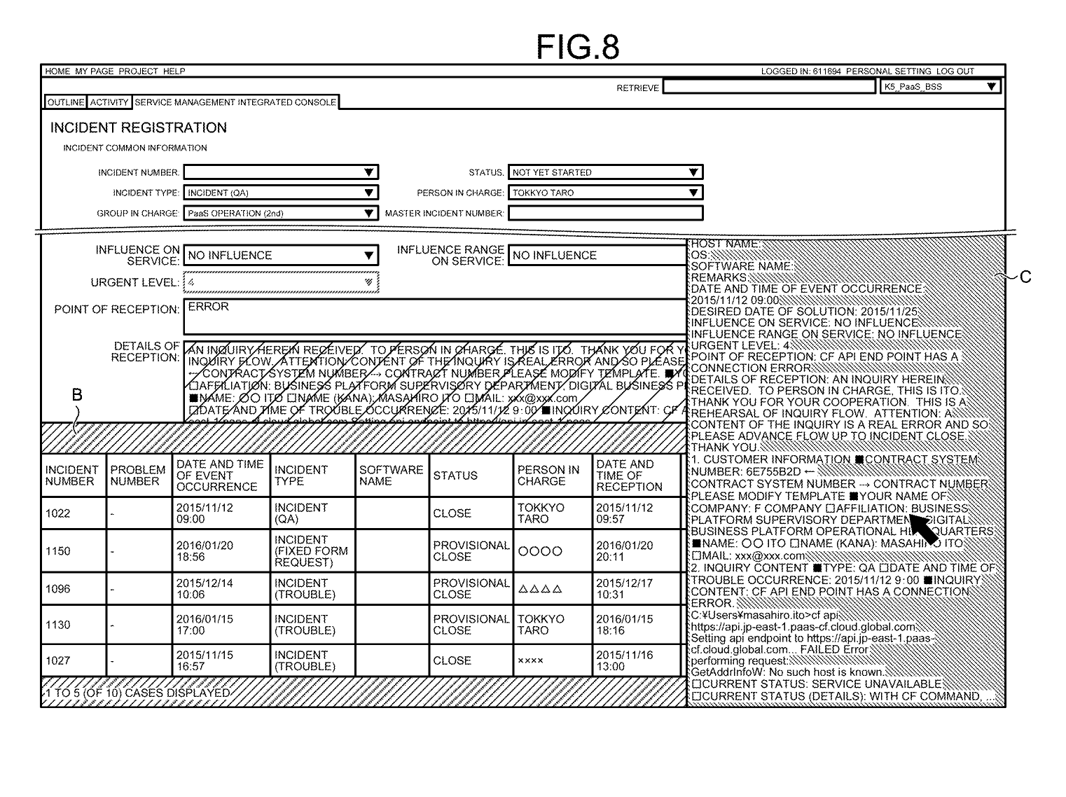

FIG. 8 is a diagram illustrating an example of an operation at the time of the right click. The screen illustrated in FIG. 8 indicates a state in which the retrieval result screen B and the modal C are displayed on the incident registration screen. In this state, when the right click processing unit 22 detects the right click on the modal C, the right click processing unit 22 identifies a tag of HTML in the position where the right click has been detected, and extracts an item name “details of reception” and a character string “an inquiry has been herein received. To the person in charge, this is Ito. Thank you for your cooperation. The inquiry is . . . (omission)” specified by the tag. Then, the right click processing unit 22 holds the character string “an inquiry has been herein received. To the person in charge, this is Ito. Thank you for your cooperation. The inquiry is . . . (omission)” as a variable of the script.

Next, the right click processing unit 22 identifies the extracted item name “details of reception” from the items on the registration screen of the incident, and transcribes the character string “an inquiry has been herein received. To the person in charge, this is Ito. Thank you for your cooperation. The inquiry is . . . (omission)” held as the variable of the script to the identified item name “details of reception”. In a case where the character string is transcribed by the right click processing unit 22, retrieval processing is not executed.

Note that the retrieval processing may be performed for the character string pasted from the clipboard 12. For example, the retrieval execution unit 16 can determine that the input is made by paste when the input character string and the character string held on the clipboard 12 are matched.

The detection of the right click, and detection of the right-clicked position and the tag can be performed using functions of the script. However, an embodiment is not limited thereto, and various known technique can be employed.

The editing unit 23 is a processing unit that executes an input and deletion of the character string to the registration screen of the incident. To be specific, the editing unit 23 receives inputs to the items on the registration screen of the incident. When the character string and the like have been received, the retrieval execution unit 16 sets the input character string and the like as the retrieval keywords, and executes the retrieval processing.

Further, the editing unit 23 detects an increase/decrease in the already input character string, the character string pasted from the clipboard 12, and the character string transcribed by the right click processing unit 22. When the increase/decrease in the character string is detected, the retrieval execution unit 16 sets the increased/decreased character string as the retrieval keyword, and issues the retrieval query.

The registration execution unit 24 is a processing unit that executes the registration of the incident. To be specific, when pressing of a “registration button” on the incident registration screen or the like is executed, the registration execution unit 24 issues the registration query including the information input on the incident registration screen at that time to the incident DB server 50.

Functional Configuration of Incident DB Server 50

As illustrated in FIG. 3, the incident DB server 50 includes a communication control unit 51, an incident DB 52, and a control unit 53.

The communication control unit 51 is a processing unit that controls communication between the own server and other devices such as the terminal device 10, and is, for example, a network interface card. For example, the communication control unit 51 executes control regarding the Web browser between the own server and the terminal device 10. Further, the communication control unit 51 receives the retrieval query and the registration query from the terminal device 10, and transmits the retrieval results and various replies to the terminal device 10.

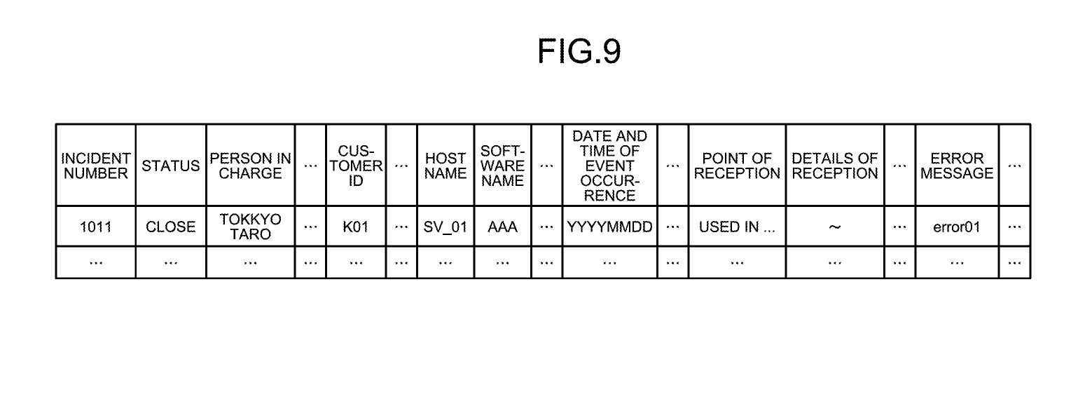

The incident DB 52 is a database that stores the incident registered by the terminal device 10, and is stored in a memory or a hard disk, for example. FIG. 9 is a diagram illustrating an example of information stored in the incident DB 52. As illustrated in FIG. 9, the incident DB 52 stores “an incident number, a status, a name of a person in charge, . . . , a customer ID, . . . , a host name, a software name, . . . , date and time of occurrence of event, . . . , a point of reception, details of reception, . . . , an error message, . . . , and the like”.

The “incident number” stored here is an identifier that identifies the incident, and is uniquely allocated. The “status” is a state of the inquiry (incident), and ‘close’ indicating that the problem has been solved, ‘provisional close” indicating that the response has been made, and the like are set. The “name of a person in charge” is a name of a person in charge who has registered the incident, the “customer ID” is an identifier of a customer for whom an event has occurred, the “host name” is a name of the server (host) in which an event has occurred, and the “software name” is a name of software in which an event has occurred. The “date and time of occurrence of event” is date and time when an event has occurred, the “point of reception” is a point of content of the inquiry (event), the “details of reception” is details of the content of the inquiry (event), and the “error message” is an error message detected in the system at the time of occurrence of an event.

The control unit 53 is a processing unit that controls processing of the entire incident DB server 50, and is, for example, a processor. The control unit 53 includes a retrieval query execution unit 54 and a registration query execution unit 55. Note that the retrieval query execution unit 54 and the registration query execution unit 55 are examples of electronic circuits included in the processor or examples of processes executed by the processor.

The retrieval query execution unit 54 is a processing unit that executes the retrieval query. To be specific, when the retrieval query execution unit 54 receives the retrieval query from the terminal device 10, the retrieval query execution unit 54 retrieves an appropriate incident from the incident DB 52, and replies to the terminal device 10 with the retrieval results. For example, when the retrieval query execution unit 54 receives the retrieval query “point of reception: error”, the retrieval query execution unit 54 performs full text retrieval for all the items of the incidents registered to the incident DB 52, and replies with the incidents including the “error” as the retrieval results.

The registration query execution unit 55 is a processing unit that executes the registration query. To be specific, when the registration query execution unit 55 receives the registration query from the terminal device 10, the registration query execution unit 55 acquires the incident information included in the registration query and the incident information input to the Web browser, and assigns the incident numbers and registers the information to the incident DB 52.

### Specific Example

Next, processing by the left click and processing by the right click will be described using a specific example. Note that, here, simplified information from which the information displayed on the incident registration screen and on the modal is omitted will be exemplarily described. For example, assume that “the customer ID, the host name, the software name, and the point of reception” as the inputting items, and the modal C are displayed on the incident registration screen. Further, assume that “the customer ID: K01, the host name: SV01, the software name: SW01, and the point of reception: an error has occurred ˜˜˜” are displayed on the modal C.

Description of Click Operation

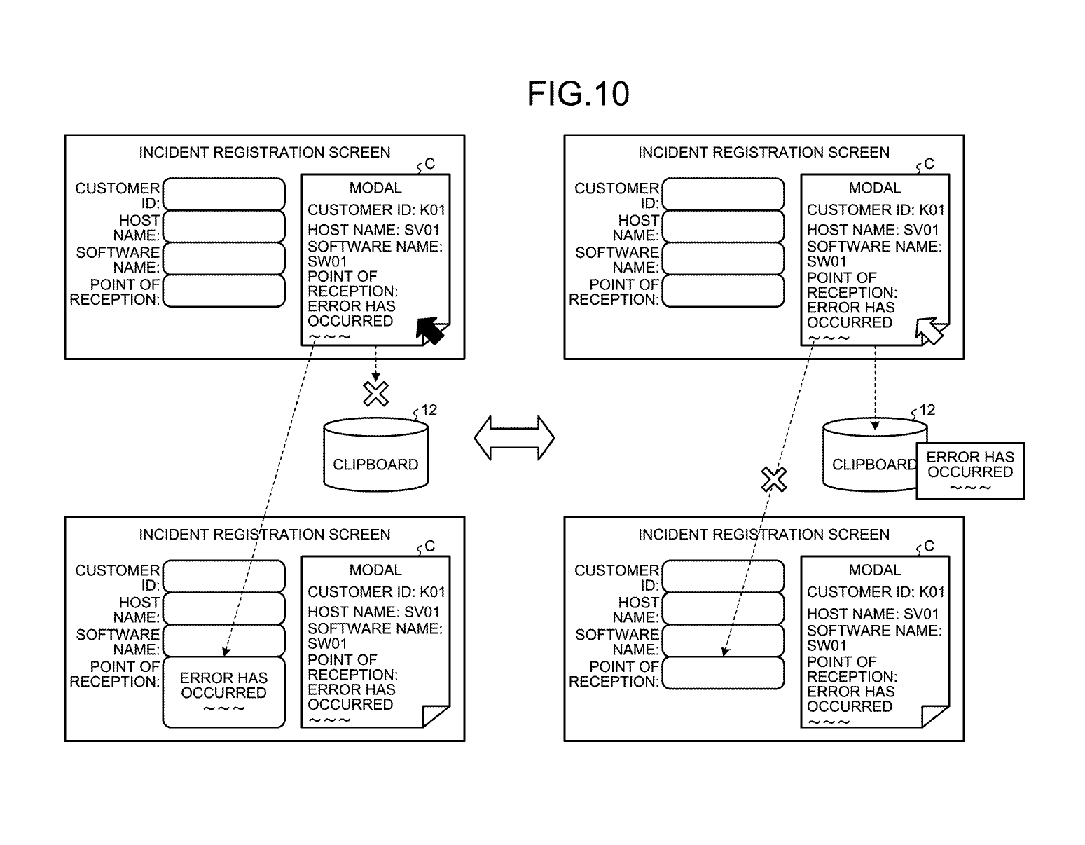

FIG. 10 is a diagram for describing a click operation. The left diagram of FIG. 10 is a diagram for describing an operation at the time of the right click. As illustrated in the left diagram of FIG. 10, when the right click processing unit 22 detects the right click on the “point of reception: an error has occurred ˜˜˜” on the modal C, the right click processing unit 22 transcribes the “error has occurred ˜˜˜” to the “point of reception” that is the same item on the incident registration screen without executing copy to the clipboard 12.

Meanwhile, the right diagram of FIG. 10 is a diagram for describing an operation at the time of the left click. As illustrated in the right diagram of FIG. 10, when the left click processing unit 21 detects the left click on the “point of reception: an error has occurred ˜˜˜” on the modal C, the left click processing unit 21 copies the “error has occurred ˜˜˜” to the clipboard 12, but does not execute transcription to the “point of reception” that is the same item on the incident registration screen.

Successive Processing of Click Operations

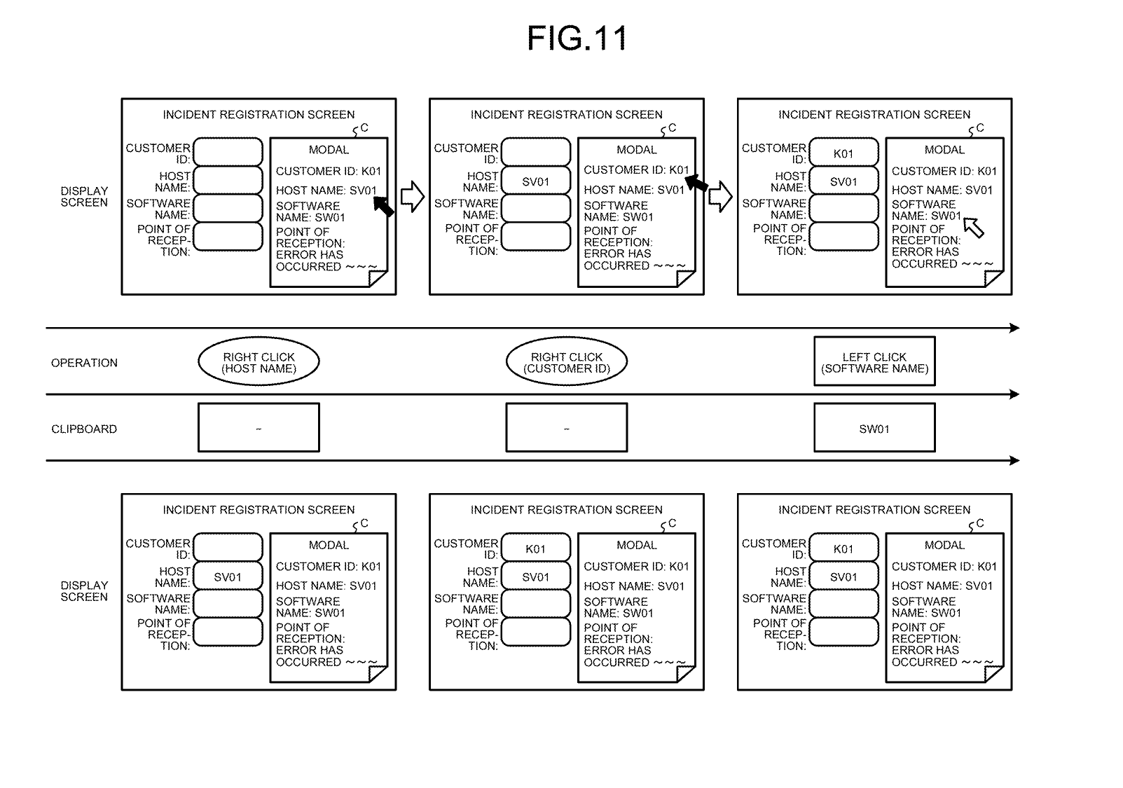

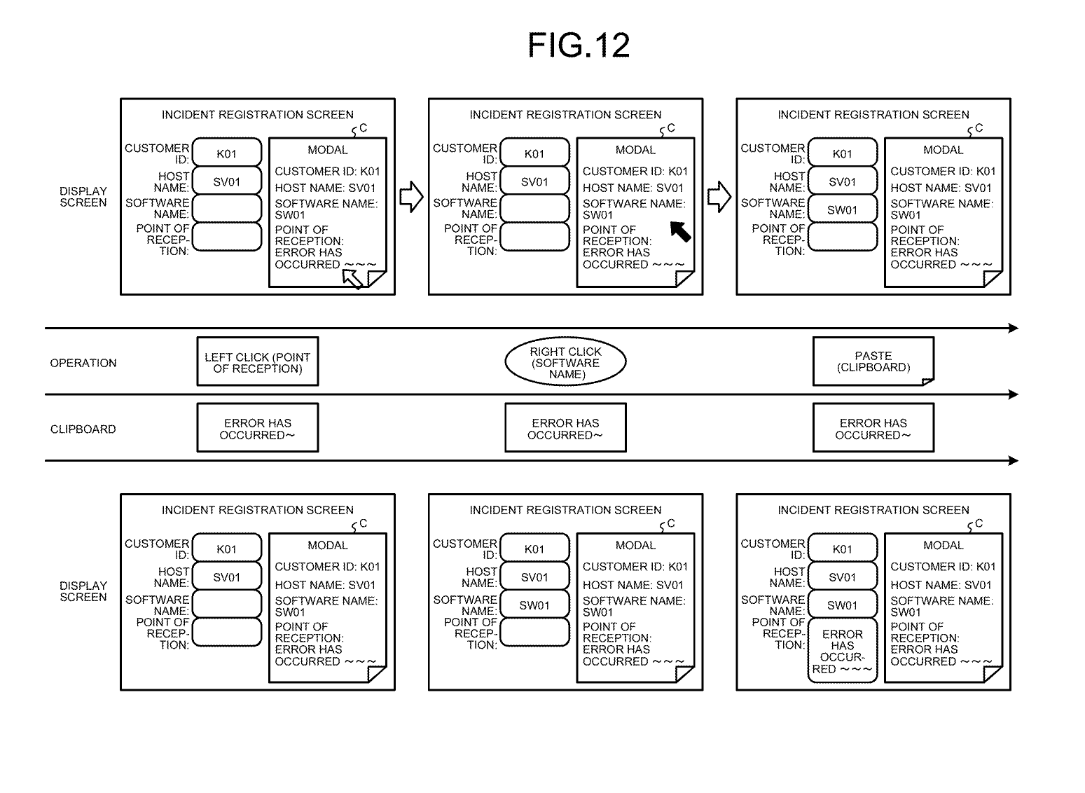

FIGS. 11 and 12 are diagrams for describing successive processing by click operations. In FIGS. 11 and 12, transition of display screens and the like by the successively received click operations will be described using “a display screen of the incident registration screen that has received by the click operation, an operation, a storage state of the clipboard 12, and a display screen of the incident registration screen after the click operation”.

As illustrated in FIG. 11, when the right click processing unit 22 detects the right click on the “host name: SV01” on the modal C, the right click processing unit 22 transcribes the “SV01” to the “host name” on the incident registration screen without performing copy to the clipboard 12.

Next, when the right click processing unit 22 detects the right click on the “customer ID: K01” on the modal C, the right click processing unit 22 transcribes the “K01” to the “customer ID” on the incident registration screen without performing copy to the clipboard 12.

Further, next, when the left click processing unit 21 detects the left click on the “software name: SW01” on the modal C, the left click processing unit 21 copies the character string “SW01” surrounded by the tag to the clipboard 12. At this time, the incident registration screen as the display screen is unchanged from the state where the left click has been received.

Next, as illustrated in FIG. 12, when the left click processing unit 21 detects the left click on the “point of reception: an error has occurred ˜˜˜” on the modal C, the left click processing unit 21 copies the character string “an error has occurred ˜˜˜” surrounded by the tag and overwrites the clipboard 12 with the character string. Therefore, the clipboard 12 overwrites the already stored “SW01” with the “error has occurred ˜˜˜”. Note that the incident registration screen as the display screen is unchanged.

Further, when the right click processing unit 22 detects the right click on the “software name: SW01” on the modal C, the right click processing unit 22 transcribes the “SW01” to the “software name” on the incident registration screen without performing copy to the clipboard 12. At this time, the clipboard 12 keeps the “error has occurred ˜˜˜” stored.

Further, next, the left click processing unit 21 pastes the “error has occurred ˜˜˜” stored on the clipboard 12 to the “point of reception” on the incident registration screen. At this time, the clipboard 12 keeps the “error has occurred ˜˜˜” stored.

As described above, by simply right-clicking the information on the modal C, the appropriate input content can be input to the appropriate item on the incident registration screen. Further, the content to be edited, of the incident information retrieved and displayed on the modal C, can be registered to the incident registration screen after edited to the clipboard 12.

Right Click Operation

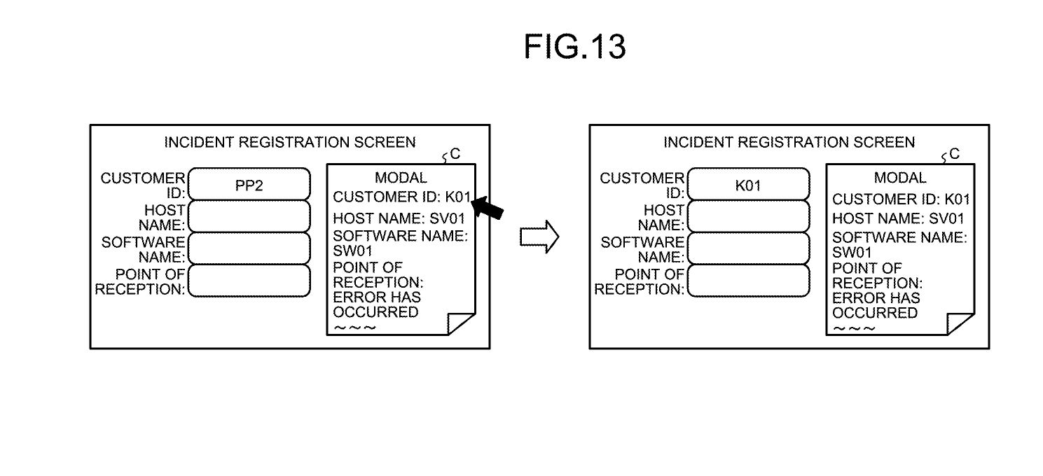

Next, processing of when the inputting item to which the character string has already been input is right-clicked on the modal C will be described. FIG. 13 is a diagram for describing overwrite by a right click operation.

As illustrated in the left diagram of FIG. 13, when the right click processing unit 22 detects the right click on the “customer ID: K01” on the modal C in a state where “PP2” is input to the customer ID on the incident registration screen, the right click processing unit 22 holds the “K01” as a variable of the script without performing copy to the clipboard 12. Then, the right click processing unit 22 transcribes the “K01” to the “customer ID” on the incident registration screen corresponding to the right-clicked “customer ID”. At this time, the right click processing unit 22 overwrites the already input “PP2” with the transcribed “K01”.

Trigger of Retrieval Processing

In the above description, a specific technique to input the character string to the incident registration screen has been described. However, in reality, when a character string that satisfies a predetermined condition is input, the retrieval result screen B is automatically uprated. That is, when an input that satisfies a predetermined condition has occurred, the automatic retrieval is executed. Therefore, here, the retrieval processing will be described. Note that “determination as to whether no operation continues for 1.5 seconds or more” included in the predetermined condition is omitted.

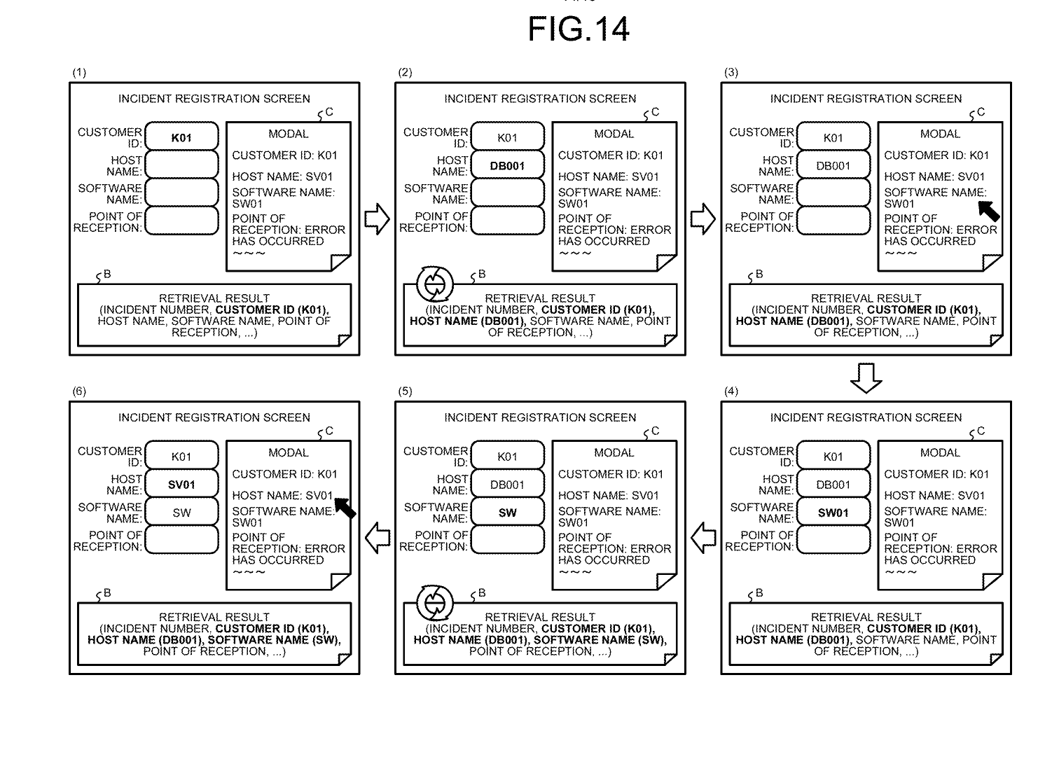

FIG. 14 is a diagram for describing execution trigger of the retrieval processing. As illustrated in (1) of FIG. 14, when the retrieval execution unit 16 detects an input (manual input) of “K01” to the customer ID on the incident registration screen, the retrieval execution unit 16 issues the retrieval query of the “customer ID: K01” to the incident DB server 50. As a result, the retrieval execution unit 16 receives the retrieval result of the incident including the “K01” from the incident DB server 50, and displays the retrieval result on the retrieval result screen B.

Next, as illustrated in (2) of FIG. 14, when the retrieval execution unit 16 detects an input (manual input) of “DB001” to the host name on the incident registration screen, the retrieval execution unit 16 issues the retrieval query including the “customer ID: K01” and the “host name: DB001” to the incident DB server 50. As a result, the retrieval execution unit 16 receives the retrieval results of the incidents including the “DB001” or the “K01” from the incident DB server 50, and updates the retrieval result screen B.

Next, as illustrated in (3) of FIG. 14, when the right click processing unit 22 detects the right click on the “software name: SW01” on the modal C, the right click processing unit 22 transcribes the “SW 01” to the “software name” on the incident registration screen without performing copy to the clipboard 12. At this time, as illustrated in (4) of FIG. 14, the retrieval execution unit 16 determines that the input operation is the transcription by the right click, and restrains issuance of the retrieval query. As a result, the retrieval result screen B is unchanged from (3) of FIG. 14 although the new character string has been input to the incident registration screen.

Here, as a technique of the retrieval execution unit 16 to determine whether the input character string is made by transcription, various types of processing can be employed. For example, the retrieval execution unit 16 can determine that the input is made by transcription when the input character string and the character string held as a variable of the script are matched. Further, the retrieval execution unit 16 can determine that the input is made by transcription when the input is made without character conversion and the like.

Then, the retrieval execution unit 16 detects that the “SW01” transcribed by the right click is changed to “SW”, for the software name on the incident registration screen, as illustrated in (5) of FIG. 14. That is, the retrieval execution unit 16 detects that the transcribed character string has been edited. Then, the retrieval execution unit 16 generates a new retrieval query “software name: “SW”, in addition to the retrieval query “customer ID: K01” and “host name: DB001” so far, and issues a retrieval query including these three. As a result, the retrieval execution unit 16 receives the retrieval results of the incidents including any of the “SW”, “DB001”, and “K01” from the incident DB server 50, and uprates the retrieval result screen B.

Next, as illustrated in (6) of FIG. 14, when the right click processing unit 22 detects the right click on the “host name: SV01” on the modal C, the right click processing unit 22 transcribes the “SV01” to the “host name” on the incident registration screen without performing copy to the clipboard 12. At this time, the retrieval execution unit 16 determines that the input operation is the transcription by the right click, and restrains issuance of the retrieval query. As a result, the retrieval result screen B is unchanged from (5) of FIG. 14 although the new character string has been input to the incident registration screen.

Flows of Processing

Next, flows of the above-described processing will be described. Here, the retrieval processing, duplication processing by the left click, and transcription processing by the right click will be described.

Flow of Retrieval Processing

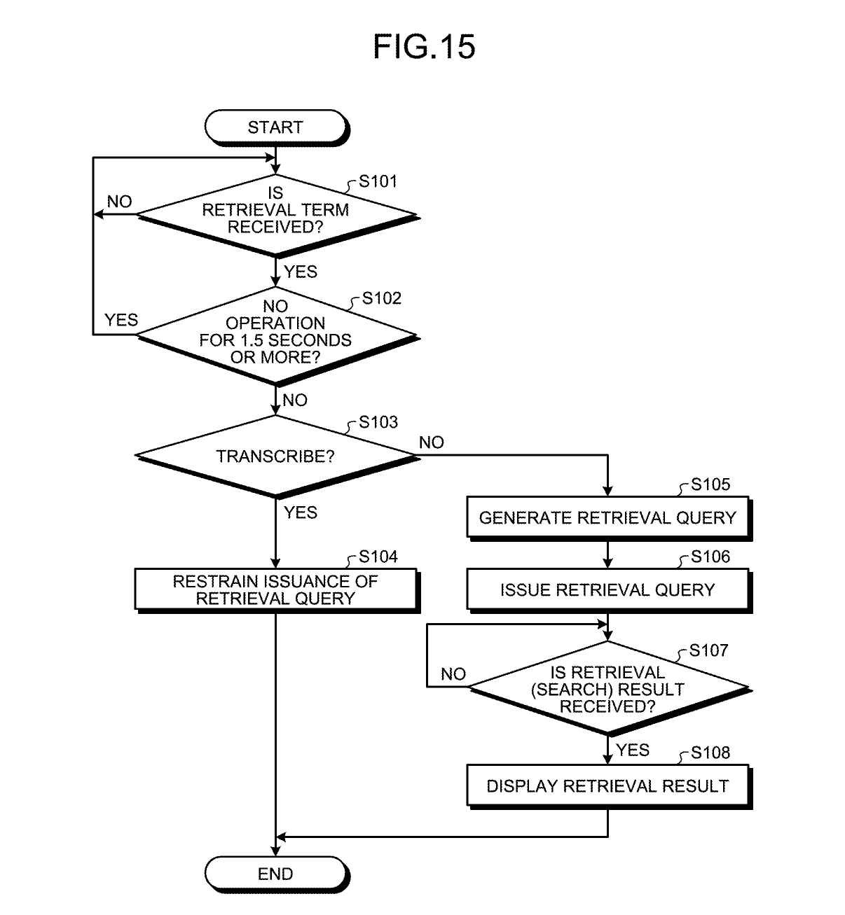

FIG. 15 is a flowchart illustrating a flow of the retrieval processing. When the retrieval execution unit 16 of the terminal device 10 receives an input of the character string (retrieval term) including an increase/decrease in the number of characters and a new input on the incident registration screen (Yes in S101), the retrieval execution unit 16 determines whether no operation continues for 1.5 seconds or more (S102).

Then, when the retrieval execution unit 16 detects a new operation (input) within 1.5 seconds (Yes in S102), the retrieval execution unit 16 repeats S101 and subsequent steps. On the other hand, when no operation continues for 1.5 seconds or more (No in S102), the retrieval execution unit 16 determines whether the input operation is the transcription by the right click (S103).

Then, when the input operation is the transcription by the right click (Yes in S103), the retrieval execution unit 16 restrains issuance of the retrieval query (S104).

On the other hand, when the input operation is not the transcription by the right click (No in S103), the retrieval execution unit 16 generates the retrieval query including the input item name and the character string (S105), and issues the retrieval query to the incident DB server 50 (S106).

After that, when the retrieval execution unit 16 receives the retrieval result from the incident DB server 50 (Yes in S107), the retrieval execution unit 16 displays the retrieval result (S108).

Flow of Duplication Processing by Left Click

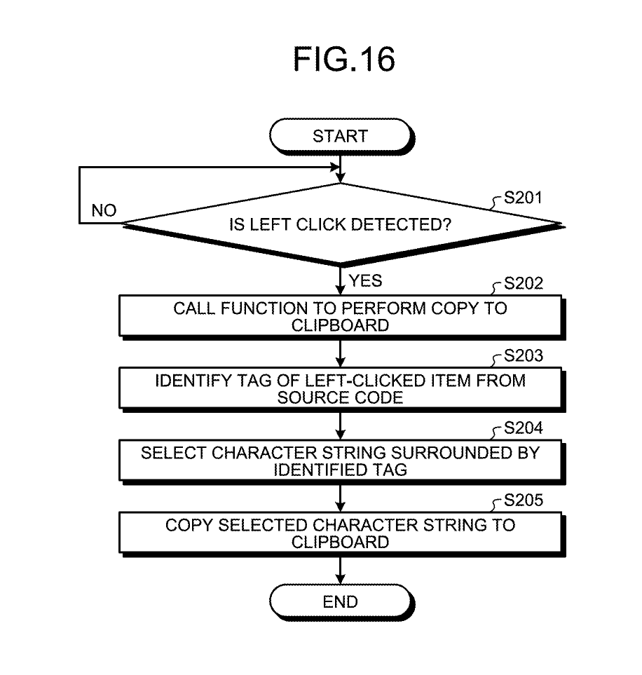

FIG. 16 is a flowchart illustrating a flow of duplication processing. When the left click processing unit 21 of the terminal device 10 detects the left click on the modal (Yes in S201), the left click processing unit 21 calls a function to perform copy to the clipboard 12 (S202).

Next, the left click processing unit 21 identifies a tag of the left-clicked item from a source code (S203), and selects the character string surrounded by the identified tag (S204). After that, the left click processing unit 21 copies the selected character string to the clipboard 12 (S205).

Flow of Transcription Processing by Right Click

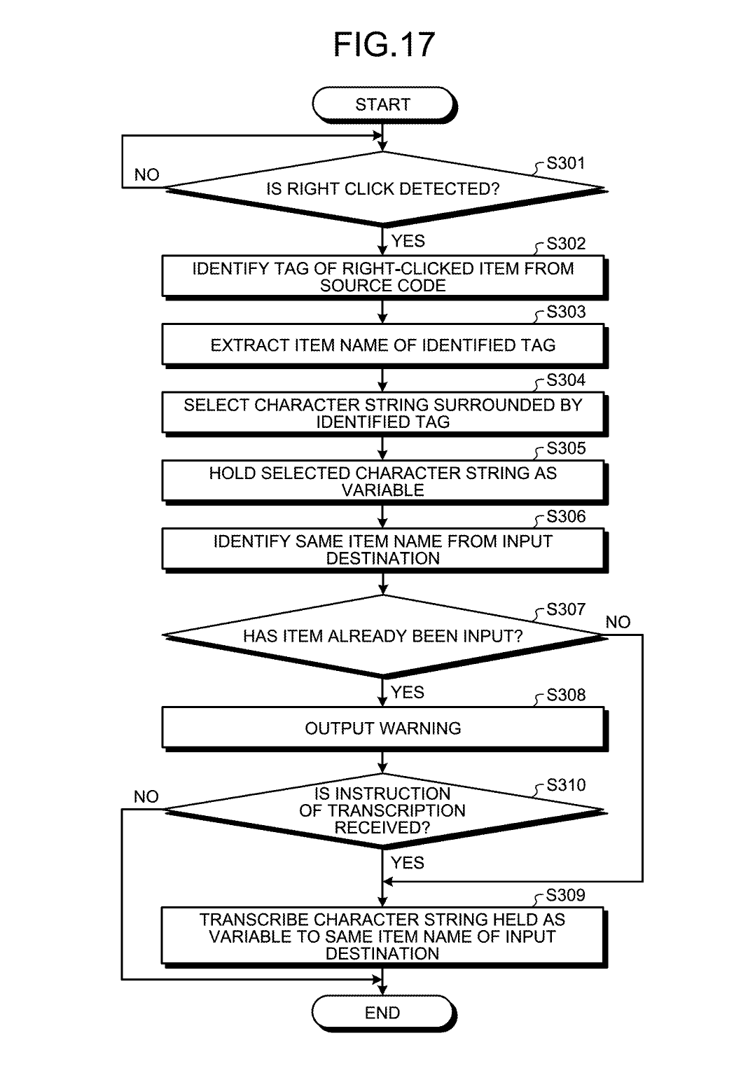

FIG. 17 is a flowchart illustrating a flow of transcription processing. When the right click processing unit 22 of the terminal device 10 detects the right click on the modal (Yes in S301), the right click processing unit 22 identifies a tag corresponding to the right-clicked item from the source code (S302), and extracts the item name of the identified corresponding tag (S303).

Next, the right click processing unit 22 selects the character string surrounded by the identified tag (S304), and holds the selected character string as the variable of the script (S305).

Then, the right click processing unit 22 identifies the same item name as the item name extracted in S303, from the incident registration screen as an input destination (S306), and determines whether the character string has already been input to the item name (S307).

Here, when the character string has not yet been input to the identified item name (No in S307), the right click processing unit 22 transcribes the character string held as the variable to the same item name of the input destination (S309).

On the other hand, when the character string has already been input to the identified item name (Yes in S307), the right click processing unit 22 outputs warning (S308), and then outputs a message, inquiring whether transcription is to be performed (S310).

Then, in a case where the right click processing unit 22 receives an instruction to perform transcription (Yes in S310), the right click processing unit 22 executes the transcription (S309). In a case where the right click processing unit 22 does not receive the instruction to perform the transcription (No in S310), the right click processing unit 22 terminates the processing without executing the transcription.

Effect

As described above, when inputting and registering the plurality of items like the incident, the terminal device 10 can distinguish and execute the information to be transcribed from the past incident and the information to be duplicated and edited, by the simple click operations. Therefore, efficiency of information registration differently using duplication and utilization can be improved.

For example, in a case where a plurality of failures occurs or failures occur on different dates in the same software or the same system, it takes time to manually input the software name and the host name. In such a case, the transcription by the right click enables successive transcription, thereby to simplify the operation of the manager and reduce the load of the manager.

Meanwhile, as for the point of reception or the like, the inquiry content identifies the failure content, and is thus very specific and executes registration of long content. However, in a case of a similar inquiry or failure, similar content has sometimes already been registered, where the similar inquiry or failure is only partially different (for example, only the error message is different) from the content registered in the point of reception of the past incident. In such a case, by executing the duplication by the left click, the editing function by the manager can be provided on the clipboard 12. Therefore, the time needed for incident registration and the load of the manager can be reduced.

### [b] Second Embodiment

An embodiment of the present invention has been described. However, the present invention may be implemented in various different forms other than the above-described embodiment.

Script

The script described in the above-described embodiment is an example, and an embodiment is not limited to the example. For example, other technologies that allow an execution environment to be incorporated in a Web browser or the like can be employed. A Web browser including an execution environment of a script having a similar function to the above-described script can be operated on the present system. Further, various known algorithms can be employed as an algorithm of full text retrieval.

Object to be Transcribed/Copied

In the above-described embodiment, a character string has been used as the object to be transcribed or copied. However, an embodiment is not limited thereto. For example, data such as characters, images, and sounds can be similarly processed. Further, in the above-described embodiment, an example in which the right click corresponds to the transcription and the left click corresponds to the copy has been described. However, an embodiment is not limited to the example, and the right click may correspond to the copy and the left click may correspond to the transcription.

System

Further, the configurations of the devices illustrated in FIG. 3 are not always physically configured as illustrated in the drawings. That is, the configurations can be distributed or integrated in arbitrary units. For example, the retrieval execution unit 16 and the registration unit 20 can be integrated. Further, all or an arbitrary part of the processing functions performed in the devices can be realized by a central processing unit (CPU) and programs analyzed and executed by the CPU, or can be realized as hardware by a wired logic.

Further, all or a part of the processing described as those automatically performed, of the processing described in the present embodiment, can be manually performed. Further, all or a part of the processing described as those manually performed can be automatically performed by known methods. In addition, the information including the processing procedures, control procedures, specific names, and various data and parameters described and illustrated in the above texts and drawings can be arbitrarily changed unless otherwise specified.

Hardware

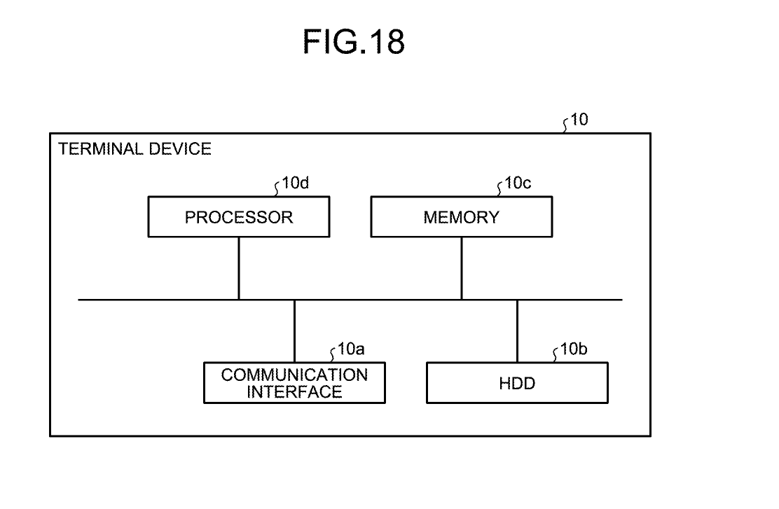

The terminal device 10 can be realized by a computer having a hardware configuration as follows, for example. FIG. 18 is a diagram for describing an example of a hardware configuration. As illustrated in FIG. 18, the terminal device 10 includes a communication interface 10a, a hard disk drive (HDD) 10b, a memory 10c, and a processor 10d.

An example of the communication interface 10a includes a network interface card. The HDD 10b is a storage device that stores programs and data.

Examples of the memory 10c include a random access memory (RAM) such as a synchronous dynamic random access memory (SDRAM), a read only memory (ROM), and a flash memory. Examples of the processor 10d include a CPU, a digital signal processor (DSP), a field programmable gate array (FPGA), and a programmable logic device (PLD).

Further, the terminal device 10 is operated as an information processing apparatus that executes an input assistance method, by reading and executing a program. That is, the terminal device 10 executes a program that executes similar functions to an access unit 14, a retrieval unit 15, and a registration unit 20. As a result, the terminal device 10 can execute a process that executes similar functions to the access unit 14, the retrieval unit 15, and the registration unit 20. Note that the program referred in this another embodiment is not limited to be executed by the terminal device 10. For example, the present invention can be similarly applied to a case in which another computer or server executes the program and a case where the program is executed by other computer and server in cooperation with each other.

This program can be distributed through a network such as the Internet. Further, this program can be executed by being recorded on a computer-readable recording medium such as a hard disk, a flexible disk (FD), a CD-ROM, a magneto-optical disk (MO), or a digital versatile disc (DVD), and read by a computer from the recording medium.

According to the embodiments, efficiency of information registration differently using duplication and utilization can be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An input assistance method comprising:
accepting, in an incident case including a plurality of items in operation management, a first click operation to a specific item of the incident case retrieved in response to an input of at least any of the plurality of items, using a processor; and
duplicating a content of the specific item of the incident case to an inputting item corresponding to the specific item in response to the first click operation, using the processor.

2. The input assistance method according to claim 1, wherein
the duplicating includes duplicating duplication by the first click operation without accumulating the content of the specific item to a clipboard.

3. The input assistance method according to claim 1, wherein the process further comprises accumulating the content of the specific item of the incident case to a clipboard in response to a second click operation to the specific item of the incident case, the second click operation being different from the first click operation, using the processor.

4. A non-transitory computer-readable recording medium having stored therein an input assistance program that causes a computer to execute a process comprising:
accepting, in an incident case including a plurality of items in operation management, a first click operation to a specific item of the incident case retrieved in response to an input of at least any of the plurality of items; and
duplicating a content of the specific item of the incident case to an inputting item corresponding to the specific item in response to the first click operation.

5. An input assistance device comprising:
a processor configured to:
accept, in an incident case including a plurality of items in operation management, a first click operation to a specific item of the incident case retrieved in response to an input of at least any of the plurality of items; and
duplicate a content of the specific item of the incident case to an inputting item corresponding to the specific item in response to the first click operation.
